(19) United States
(12) Patent Application Publication
(10) Pub. No.: US 2012/0142351 A1
(43) Pub. Date: Jun. 7, 2012

(54) CELLULAR SYSTEM AND HAND-OFF QUALITY IMPROVEMENT METHOD

(75) Inventors: Daigo TAKAYANAGI, Yokohama (JP); Keiji USUBA, Kawasaki (JP); Tsuyoshi TAMAKI, Machida (JP)

(73) Assignee: Hitachi, Ltd.

(21) Appl. No.: 13/301,427

(22) Filed: Nov. 21, 2011

(30) Foreign Application Priority Data
Dec. 3, 2010 (JP) 2010-270354

(51) Int. Cl. H04W 36/34

(52) U.S. Cl. 455/436

(57) ABSTRACT

A base station calculates numerical value data regarding hand-off quality by carrier and by neighbor station. The base station transmits the calculated numerical value data to a management apparatus. The base station receives an improvement instruction from the management apparatus, changes transmission electric power or a transmission direction of an electric wave of a carrier designated with the improvement instruction. The management apparatus determines an improvement subject base station and an improvement subject carrier from a management table using previously-set improvement determination conditions. The management apparatus transmits the improvement instruction to change the transmission electric power or transmission direction of the electric wave of the improvement subject carrier to the improvement subject base station.

### CLAIM OF PRIORITY

The present application claims priority from Japanese patent application serial no. 2010-270354, filed on Dec. 3, 2010, the content of which is hereby incorporated by reference into this application.

### BACKGROUND OF THE INVENTION

The present invention relates to a cellular system and a hand-off quality improvement method, and more particularly, to a cellular system and a hand-off quality improvement method to improve hand-off quality.

As a cellular system, a system using a multi-carrier base station to support plural carriers with one terminal is known. As a multi-carrier base station, a multi-carrier base station to perform communication with a terminal by single carrier communication and accommodates plural terminals in plural carriers, and a multi-carrier base station to perform communication with a terminal by multi carrier communication, are known.

In recent years, communication in a cellular system is in transition from the former single carrier communication to the latter multi carrier communication. Published Japanese translations of PCT international Publication for patent applications No. 2003-522446 discloses a method and an apparatus to facilitate transition from cdma 2000 1X (single carrier) to cdma 2000 3X (triple carrier) in an electric communication system. In the multi carrier communication, respective carriers are often used within the same cell radius.

In a cellular system, upon inter-cell movement of a terminal, inter-base-station hand-off quality depends on stability of signal to interference-noise electric power ratio of a desired wave. However, in a large city or the like, high-density distributed macro-cell base stations mutually act as interference components. Further, a desired wave may be suddenly degreased with a building. In such case, a stable signal to interference-noise electric power ratio cannot be obtained.

As a maintenance method for maintaining hand-off quality in a cellular system, during installation of a base station, the position of installation of the base station, electric wave transmission direction, and transmission electric power are determined by computer simulation so as to obtain an optimum signal to interference-noise electric power ratio in a peripheral area. Further, after installation of the base station, an operator on a vehicle loaded with a terminal travels the site to measure an actual signal to interference-noise electric power ratio, and adjusts the electric wave transmission direction in the base station and the transmission electric power.

In place of these maintenance methods accompanied by personnel labor, a method for a system to automatically improve quality is required. Further, from a viewpoint of multi carrier, in addition to the quality improvement methods for single carrier communication, proposal of quality improvement by new approach is desired.

### SUMMARY OF THE INVENTION

The present invention proposes a method for hand-off quality improvement in a multi-carrier communication cellular system. In multi carrier communication, when the cell radii for the respective carriers are the same, electric wave environments of the respective carriers at the same point are similar to each other. Accordingly, there is a high probability that hand-off processing in all the carriers fail. In such case, the communication is completely broken. Further, when the cell radii of all the carriers are changed similarly to each other so as to improve the hand-off quality in a first point with a high probability of hand-off failure in all the carriers, even when the hand-off quality at the first point is improved, a second point with poor hand-off quality occurs in all the carriers.

Regarding some of carriers, the hand-off quality at the first point is improved by changing only the cell radii for some of carriers among the plural carriers. At the same time, even though the hand-off quality is degraded at the second point in some of the carriers, the hand-off quality at the second point is ensured in the remaining carriers. With this arrangement, hand-off can be made without communication disconnection at the first point and the second point.

Therefore, a management apparatus to manage hand-off quality is introduced in a cellular system. The management apparatus collects numerical value data regarding hand-off quality from each base station. Then the management apparatus instructs a base station in a low hand-off quality area to change transmission electric power, thereby improves the hand-off quality.

The above-described problem is solved by providing a cellular system having a plurality of base stations that perform multi-carrier communication with terminals and a management apparatus connected to these base stations, wherein the base station calculates numerical value data regarding hand-off quality by carrier and by neighbor base station, transmits the calculated numerical value data to the management apparatus, receives an improvement instruction from the management apparatus, and changes transmission electric power or a transmission direction of an electric wave of a carrier designated with the improvement instruction, and wherein the management apparatus receives the numerical value data, determines an improvement subject base station and an improvement subject carrier, and transmits the improvement instruction to change the transmission electric power or transmission direction of the electric wave of the improvement subject carrier to the improvement subject base station.

Further, the above-described problem is solved by providing a hand-off quality improvement method in a cellular system having a plurality of base stations that perform multi-carrier communication with a terminal and a management apparatus connected to these base stations, comprising the steps of: calculating numerical value data regarding hand-off quality by carrier and by neighbor base station; transmitting the calculated numerical value data to the management apparatus; receiving the calculated numerical value data; determining an improvement subject base station and an improvement subject carrier; transmitting an improvement instruction to change transmission electric power or a transmission direction and an electric wave of the improvement subject carrier to the improvement subject base station; receiving the improvement instruction; and changing the transmission electric power or transmission direction of the electric wave of the carrier designated with the improvement instruction.

In accordance with the present invention as described above, it is possible to improve hand-off quality in a multi-carrier communication cellular system.

### BRIEF DESCRIPTION OF THE DRAWINGS

Preferred embodiments of the present invention will now be described in conjunction with the accompanying drawings, in which;

FIG. 1 is a block diagram showing a configuration of a cellular system;

FIG. 2 is a block diagram showing a configuration of a management apparatus;

FIG. 3 is a block diagram showing a configuration of a base station;

FIG. 4 is a schematic diagram showing positional relation between respective carriers in base stations;

FIGS. 5A to 5C are tables showing hand-off failure rates transmitted from the base station;

FIG. 6 shows a hand-off failure rate management table;

FIG. 7 is a sequence diagram showing hand-off quality improvement between the respective base stations and the management apparatus;

FIG. 8 is a schematic diagram showing positional relation between respective carriers in base stations;

FIG. 9 is a flowchart showing hand-off quality improvement in the management apparatus;

FIG. 10 is a table showing an improvement instruction message transmitted from the management apparatus; and

FIGS. 11A to 11C are tables showing hand-off failure rates transmitted from the base station.

### DETAILED DESCRIPTION OF THE PREFERRED EMBODIMENT

Hereinbelow, an embodiment will be described in detail in accordance with the accompanying drawings. Note that substantially corresponding members have the same reference numerals, and explanations of the members will not be repeated.

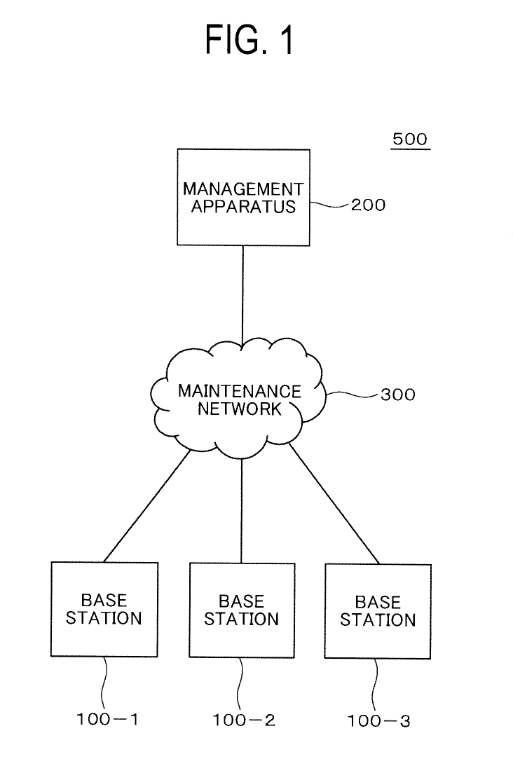

First, a configuration of a cellular system will be described with reference to FIG. 1. In FIG. 1, a cellular system 500 has base stations 100-1 to 100-3 and a management apparatus 200. The three base stations 100 and the management apparatus 200 are connected via a maintenance network 300.

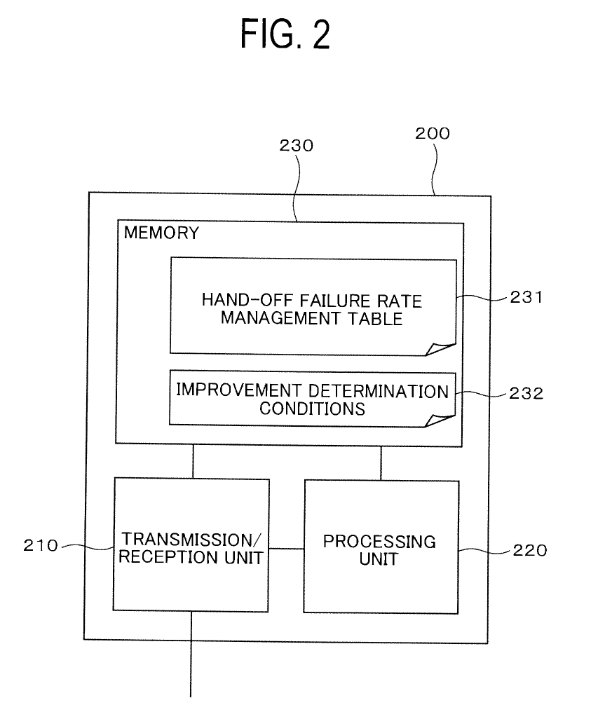

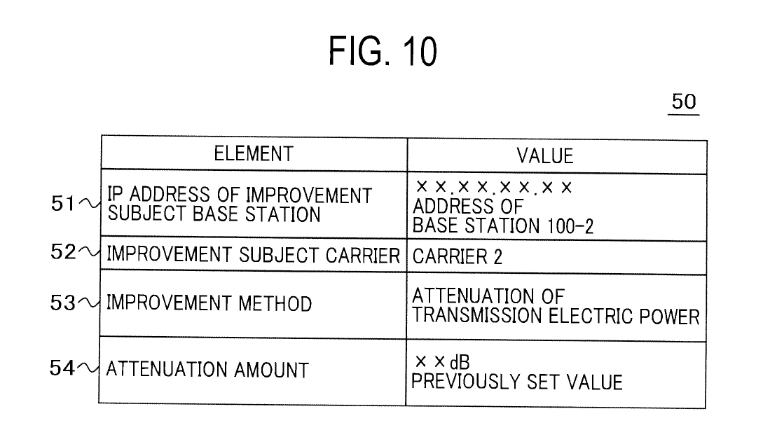

Next, a configuration of the management apparatus 200 will be described with reference to FIG. 2. In FIG. 2, the management apparatus 200 has a transmission/reception unit 210 connected to the maintenance network 300, a processing unit 220 and a memory 230. The memory 230 holds a hand-off failure rate management table 231 and improvement determination conditions 232. The transmission/reception unit 210 transmits a message to the maintenance network 300. Further, the transmission/reception unit 210 receives hand-off failure rates from the base stations 100 via the maintenance network 300. The processing unit 220 updates the hand-off failure rate management table 231 based on the received hand-off failure rates. Further, the processing unit 220 determines improvement subject base station and improvement subject carrier based on the hand-off failure rate management table 231 and the improvement determination conditions 232. The processing unit 220 generates an improvement instruction message 50 (described later with reference to FIG. 10). The processing unit 220 transmits the generated improvement instruction message 50 to the improvement subject base station via the transmission/reception unit 210.

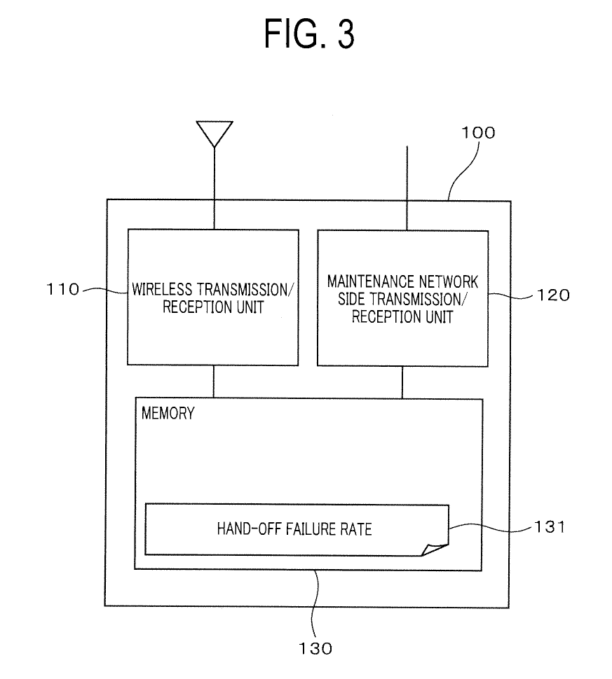

Next, a configuration of the base station will be described with reference to FIG. 3. In FIG. 3, the base station 100 has a wireless transmission/reception unit 110, a maintenance network side transmission/reception unit 120 connected to the maintenance network 300, and a memory 130. The memory 130 holds a hand-off failure rate 131.

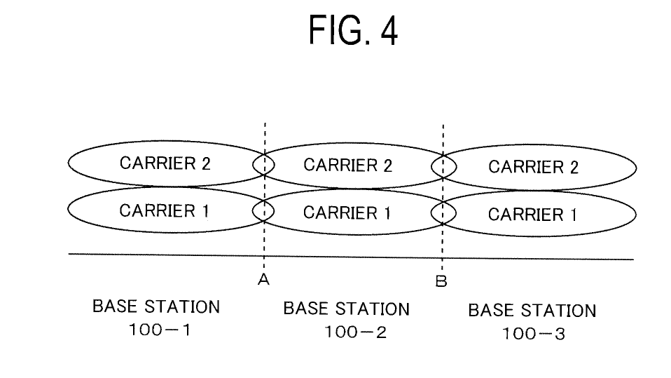

The base stations 100-1 to 100-3 are multi-carrier base stations which support two carriers (carrier 1 and carrier 2). Note that in the base stations 100-1 to 100-3, the cell radii of the respective carriers are the same. FIG. 4 shows cell positional relation between the respective carriers in the base stations 100-1 to 100-3. In FIG. 4, the horizontal axis indicates distance-based positional relation in each base station 100. On the other hand, the carrier 1 and carrier 2 are arrayed in the vertical axis direction. Note that hand-off quality is poor at a point A between the base station 100-1 and the base station 100-2 and at a point B between the base station 100-2 and the base station 100-3. In the present embodiment, how to improve the hand-off quality from this status will be described below.

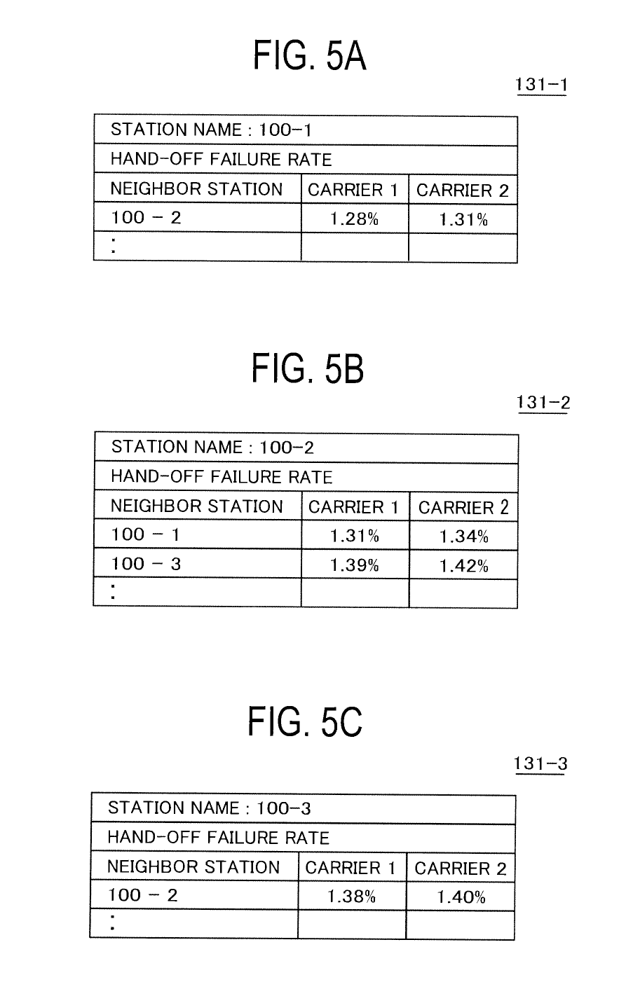

Next, the hand-off failure rates held in the respective base stations will be described with reference to FIGS. 5A to 5C. FIG. 5A shows a hand-off failure rate 131-1 in the base station 100-1. FIG. 5B shows a hand-off failure rate 131-2 in the base station 100-2. FIG. 5C shows a hand-off failure rate 131-3 in the base station 100-3.

In FIG. 5A, a neighbor base station of the base station 100-1 is the base station 100-2. The hand-off failure rate from the base station 100-1 to the base station 100-2 is 28% in the carrier 1 and 1.31% in the carrier 2. In FIG. 5B, the neighbor base stations of the base station 100-2 are the base station 100-1 and the base station 100-3. The hand-off failure rates are as shown in the figure. In FIG. 5C, the neighbor base station of the base station 100-3 is the base station 100-2. The hand-off failure rates are as shown in the figure. The base station 100 periodically transmits the hand-off failure rate to the management apparatus 200. The management apparatus 200 updates the hand-off failure rate management table 231 based on the received hand-off failure rate.

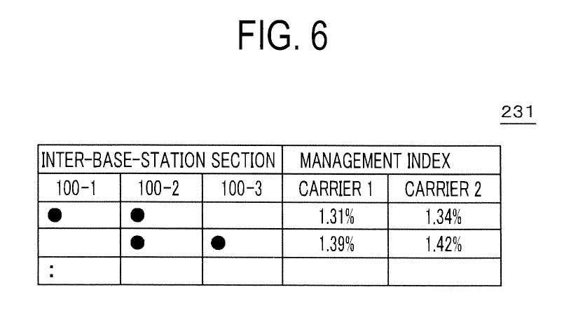

Next, the hand-off failure rate management table 231 will be described with reference to FIG. 6. In FIG. 6, it is possible to manage the hand-off failure rate by carrier regarding each inter-base-station section in the hand-off failure rate management table 231. In this figure, only the information related to the base stations 100-1 to 100-3 are shown.

The hand-off failure rate management table 231 in FIG. 6 shows a maximum value by carrier regarding each inter-base-station section in FIGS. 5A to 5C. That is, the hand-off failure rate between the base station 100-1 and the base station 100-2 marked with a black dot is 1.31% in the carrier 1 and 1.34% in the carrier 2. On the other hand, the hand-off failure rate between the base station 100-2 and the base station 100-3 is 1.39% in the carrier 1 and 1.42% in the carrier 2.

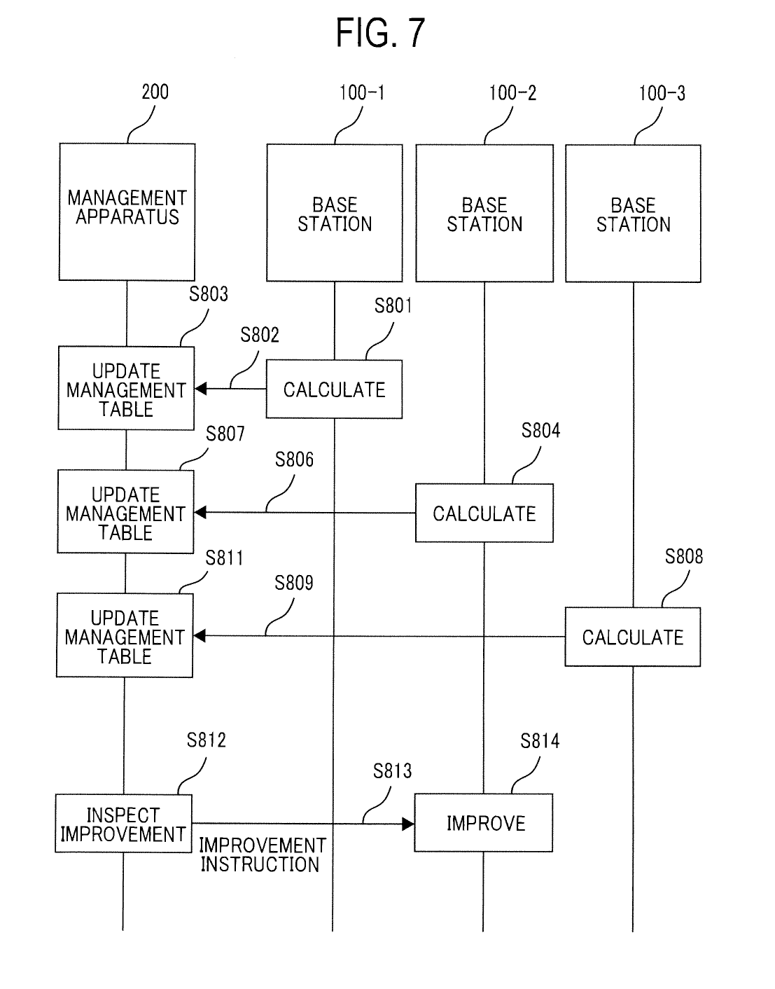

Next, communication processing between the base station 100 and the management apparatus 200 will be described with reference to FIG. 7. In FIG. 7, the base station 100-1 calculates a hand-off failure rate (S801). Note that as the calculation of the hand-off failure rate, hand-off failure rate=the number of hand-off failures/the number of hand-off tries holds. The base station 100-1 transmits the hand-off failure rate to the management apparatus 200 (S802). The management apparatus 200 updates the hand-off failure rate management table 231 using the received hand-off failure rate (S803). Note that at the respective update steps, when the received hand-off failure rate is lower than the recorded hand-off failure rate, the update is not performed.

The base station 100-2 calculates a hand-off failure rate (S804). The base station 100-2 transmits the calculated hand-off failure rate to the management apparatus 200 (S806). The management apparatus 200 updates the hand-off failure rate management table 231 using the received hand-off failure rate (S807).

The base station 100-3 calculates a hand-off failure rate (S808). The base station 100-3 transmits the calculated hand-of failure rate to the management apparatus 200 (S809). The management apparatus 200 updates the hand-off failure rate management table 231 using the received hand-off failure rate (S811).

The management apparatus 200 inspects the possibility of failure rate improvement (S812). In this embodiment, the management apparatus 200 determines the output of the base station 100-2 as an improvement subject. The management apparatus 200 transmits an improvement instruction to the base station 100-2 (S813). The base station 100-2 performs improvement in accordance with the improvement instruction from the management apparatus (S814).

The management apparatus 200 periodically studies about failure rate improvement. The management apparatus 200 compares the contents of the hand-off failure rate management table 231 with improvement determination conditions 232. In this example, the improvement determination conditions 232 are as follows.

Condition 1. Set an inter-base-station section including two carriers with a hand-off failure rate of 1% or higher as an improvement subject candidate.
Condition 2. Set a base station most related to the inter-base-station section set as an improvement subject candidate on the condition 1 as an improvement subject base station.
Condition 3. In the base station set as an improvement subject base station on the condition 2, set a carrier with the highest hand-off failure rate in the inter-base-station section related to the base station, as an improvement subject carrier.

Returning to FIG. 6, in this case, regarding the condition 1, the section between the base station 100-1 and the base station 100-2 and the section between the base station 100-2 and the base station 100-3 are the improvement subject candidates. Further, regarding the condition 2, the base station 100-2 relates to the every inter-base-station section and as relates to the maximum number of inter-base-station sections, the base station 100-2 is the improvement subject base station. Regarding the condition 3, among the inter-base-station sections related to the base station 100-2, the hand-off failure rate 1.42% in the carrier 2 between the base station 100-2 and the base station 100-3 is the highest, therefore, the carrier 2 is the improvement subject carrier.

As a result, the management apparatus 200 transmits an improvement instruction to reduce transmission electric power for the carrier 2 to the base station 100-2. The base station 100-2 receives the improvement instruction 814 from the management apparatus 200, then reduces the transmission electric power for the carrier 2 in accordance with the improvement instruction.

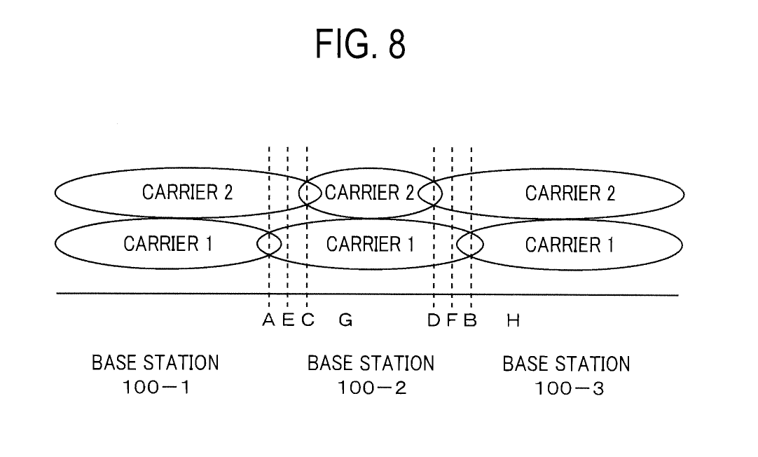

Next, cell positional relation among the base stations 100-1 to 100-3 after the execution of the improvement step will be described with reference to FIG. 8. In FIG. 8, as the base station 100-2 has reduced the transmission electric power for the carrier 2, the hand-off point in the carrier 2 is shifted to the base station 100-2 side.

With this arrangement regarding a terminal which moves from the base station 100-1 to the base station 100-3, even when hand-off failure occurs in the carrier 1 at the point A, hand-off is not made in the carrier 2 and the communication with the base station 100-1 can be continued. Accordingly, complete communication disconnection as in the case of the improvement can be avoided. Thereafter, the terminal continues the communication using the carrier 2, then at the point C where the hand-off quality is good, performs hand-off to the base station 100-2. Then again the carrier 1 is added and the multi-carrier communication can be performed. Further, at a point D, when the hand-off quality is good and hand-off to the base station 100-3 is successful in the carrier 2, the communication between the terminal and the base station 100-2 using the carrier 1 is disconnected, and communication is performed using the carrier 2 in the base station 100-3 to a point H. In the terminal, the carrier 1 in the base station 100-3 can be added from the point H and the multi-carrier communication can be performed again.

Further, in a system where the terminal is capable of simultaneous communication with plural base stations, when the terminal moves from the base station 100-1 to the base station 100-3, after the hand-off failure in the carrier 1 at the point A, the multi-carrier communication can be performed again using the carrier 2 in the base station 100-1 and the carrier 1 in the base station 100-2. In the terminal, it is also possible to perform hand-off from the base station 100-1 to the base station 100-2 in the carrier 2 at the point C. In this case, even when the hand-off quality at the point C is poor and the hand-off in the carrier 2 fails, the communication can be continued using the carrier 1. Similarly, after the hand-off failure in the carrier 2 at the point C, the multi-carrier communication is performed again using the carrier 1 and the carrier 2 in the base station 100-2 at a point G. In the terminal, upon hand-off from the base station 100-2 to the base station 100-3 in the carrier 2 at the point D, even when the hand-off quality is poor and the hand-off fails, the communication can be continued using the carrier 1. Similarly, after the hand-off failure in the carrier 2 at the point D, the multi-carrier communication can be performed again using the carrier 1 in the base station 100-2 and the carrier 2 in the base station 100-3 at the point F. In the terminal, upon hand-off from the base station 100-2 to the base station 100-3 in the carrier 1 at the point B, even when the hand-off quality is poor and the hand-off fails, the communication can be continued using the carrier 2. Thereafter, in the terminal, the multi-carrier communication can be performed again using the carrier 1 and the carrier 2 in the base station 100-3 at the point H.

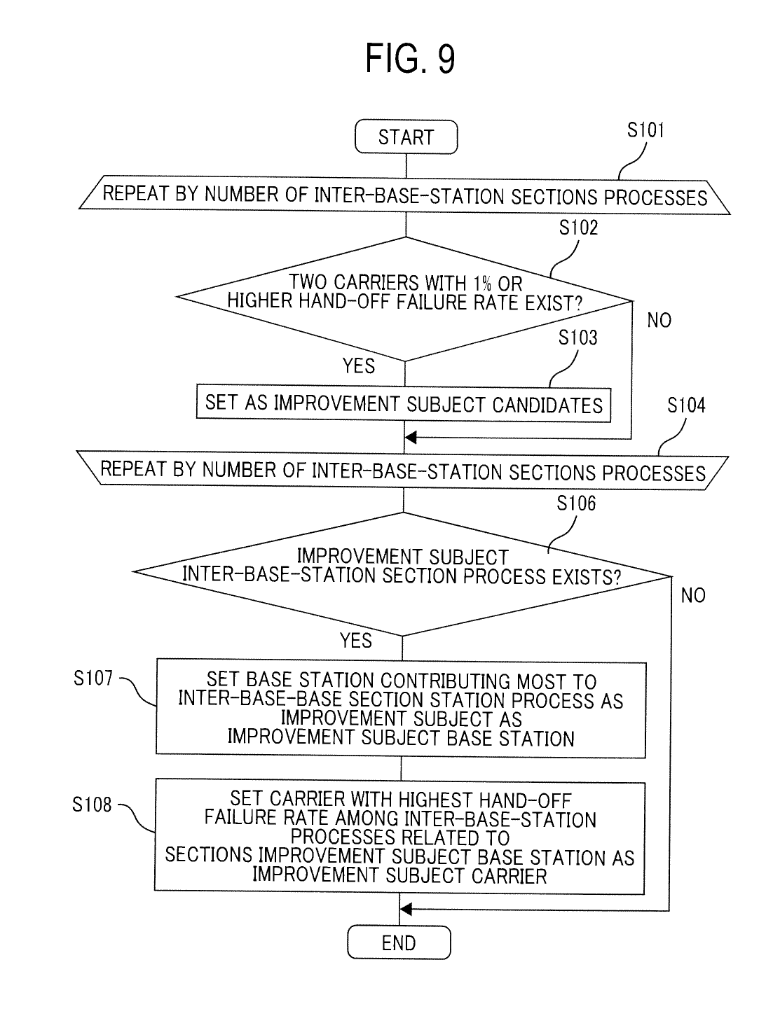

Next, a processing flow in the management apparatus 200 will be described with reference to FIG. 9. The management apparatus 200 repeats processing between steps S101 and S104 by the number of inter-base-station sections. The management apparatus 200 determines whether or not an inter-base-station section having two carriers with hand-off failure rate of 1% or higher exists (S102). When YES, the management apparatus 200 sets the inter-base-station section as an improvement subject candidate (S103). When NO at step S102, the management apparatus 200 transits to the next inter-base-station section. When all the inter-base-station sections have been checked, the management apparatus 200 determines whether or not an inter-base-station section as an improvement subject exists (S106). When YES, the management apparatus 200 sets a base station, which most contributes to the improvement-subject inter-base-station section, as an improvement subject base station (S107). The management apparatus 200 sets a carrier with highest hand-off failure rate in the inter-base-station section related to the improvement subject base station, as an improvement subject carrier (S108). Then the process ends. When NO at step S106, the management apparatus 200 terminates the process without any processing.

Next, the improvement instruction message will be described with reference to FIG. 10. In FIG. 10, the improvement instruction message 50 has an improvement subject base station IP address 51, an improvement subject carrier 52, an improvement method 53, and an attenuation amount 54. As the IP address 51 of the improvement subject base station, the IP address of an improvement subject base station is described. As the improvement subject carrier 52, the carrier number of an improvement subject carrier is described. The improvement method 53 corresponds to attenuation of transmission electric power. As the attenuation amount 54, a previously-set value is described.

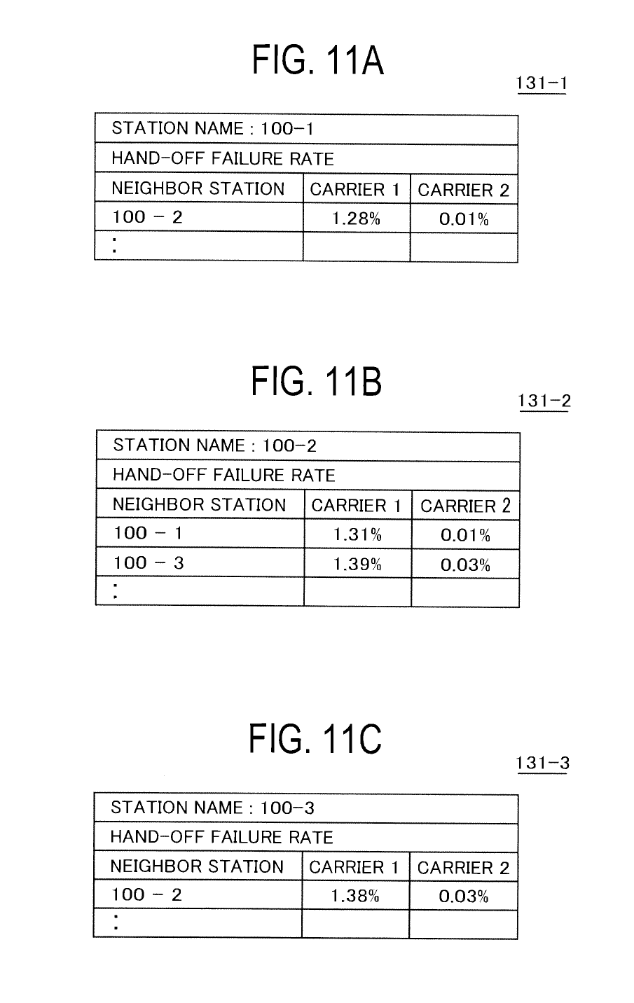

Next, an improved hand-off failure rate will be described with reference to FIGS. 11A to 11C. FIG. 11A shows the hand-off failure rate 131-1 in the base station 100-1. FIG. 11B shows the hand-off failure rate 131-2 in the base station 100-2. FIG. 11C shows the hand-off failure rate 131-3 in the base station 100-3.

In FIG. 11A, the neighbor base station of the base station 100-1 is the base station 100-2. The hand-off failure rate from the base station 100-1 to the base station 100-2 is 1.28% in the carrier 1 and 0.01% in the carrier 2. In FIG. 11B, the neighbor base station of the base station 100-2 is the base station 100-1 and the base station 100-3. The hand-off failure rates are as shown in the figure. In FIG. 11C, the neighbor base station of the base station 100-3 is the base station 100-2. The hand-off failure rates are as shown in the figure.

As it is apparent from a comparison between FIGS. 5A and 5B and FIGS. 11A to 11C, the respective failure rates are not changed in the carrier 1 but greatly improved in the carrier 2. Note that in the above-described embodiment, for the sake of simplicity of explanation, the transmission electric power is attenuated. However, it may be arranged such that a transmission direction on a subject carrier is changed.

As described above, according to the present embodiment, hand-off quality can be improved in a multi-carrier communication cellular system.

What is claimed is:

1. A cellular system having a plurality of base stations that perform multi-carrier communication with a terminal and a management apparatus connected to these base stations,
wherein the base station calculates numerical value data regarding hand-off quality by carrier and by neighbor base station, transmits the calculated numerical value data to the management apparatus, receives an improvement instruction from the management apparatus, and changes transmission electric power or a transmission direction of an electric wave of a carrier designated with the improvement instruction, and
wherein the management apparatus receives the numerical value data, determines an improvement subject base station and an improvement subject carrier, and transmits the improvement instruction to change the transmission electric power or transmission direction of the electric wave of the improvement subject carrier to the improvement subject base station.

2. The cellular system according to claim 1,
wherein the management apparatus has a memory, a transmission/reception unit and a processor, and
wherein the processing unit determines the improvement subject base station and the improvement subject carrier based on a hand-off failure rate management table and an improvement determination condition stored in the memory.

3. A hand-off quality improvement method in a cellular system having a plurality of base stations that perform multi-carrier communication with a terminal and a management apparatus connected to these base stations, comprising the steps of:
calculating numerical value data regarding hand-off quality by carrier and by neighbor base station;
transmitting the calculated numerical value data to the management apparatus;
receiving the calculated numerical value data;
determining an improvement subject base station and an improvement subject carrier;
transmitting an improvement instruction to change transmission electric power or a transmission direction and an electric wave of the improvement subject carrier to the improvement subject base station;
receiving the improvement instruction; and
changing the transmission electric power or transmission direction of the electric wave of the carrier designated with the improvement instruction.
